(19) United States
(12) Patent Application Publication
(10) Pub. No.: US 2022/0110381 A1
(43) Pub. Date: Apr. 14, 2022

(54) Surgical Apparel System Including A Peripheral Device And Method Of Operating The Peripheral Device

(71) Applicant: Stryker Corporation, Kalamazoo, MI (US)

(72) Inventors: Ryan Jefferis, Seattle, WA (US); Beau M. Kidman, Kalamazoo, MI (US); Stephen Isham, Mattawan, MI (US)

(73) Assignee: Stryker Corporation, Kalamazoo, MI (US)

(21) Appl. No.: 17/496,105

(22) Filed: Oct. 7, 2021

Related U.S. Application Data
(60) Provisional application No. 63/089,871, filed on Oct. 9, 2020.

(51) Int. Cl. A41D 13/11; A42B 3/28; A42B 3/30

(52) U.S. Cl. CPC A41D 13/1153; A42B 3/30; A42B 3/286

(57) ABSTRACT

A surgical apparel system including a surgical helmet, a surgical garment, and a power source. The surgical helmet may comprise a detector for determining the presence or absence of the surgical garment. The surgical helmet may also comprise a peripheral device and a controller for controlling operation of the peripheral device. The surgical helmet may also comprise a detector in communication with the controller, the detector configured to indicate the presence or absence of the surgical garment being disposed over the surgical helmet. The surgical helmet may also comprise one or more user inputs in communication with the controller and configured to allow the user to manipulate one or more operational characteristic of the peripheral device. The controller may be configured to control the operation of the peripheral device based on signals received from the user input and/or the detector.

### CROSS-REFERENCE TO RELATED APPLICATIONS

This patent application claims priority to and all advantages of U.S. Provisional Patent Application No. 63/089,871 filed Oct. 7, 2020, the entire contents of which are incorporated herein by reference.

### BACKGROUND

Personal protection systems are used in surgical procedures to provide a sterile barrier between the surgical personnel and the patient. Specifically, the traditional system includes a helmet that supports a toga or a hood. This system is worn by medical/surgical personnel that want to establish the sterile barrier. The toga or the hood may include a transparent face shield. The helmet includes a ventilation unit that includes a fan. The ventilation unit draws air through the toga/hood so the air is circulated around the wearer. This reduces both the amount of heat that is trapped within the toga/hood and the amount of CO₂ that builds up in this space. It is further known to mount a light to the helmet, which may be directed to illuminate the surgical site.

Conventional togas or hoods have been configured to be removably coupled to the helmet. This allows the toga/hood to be removed from the helmet following a surgical procedure and to be disposed of. As the ventilation unit is configured to circulate air on the surgical personnel side of the barrier, controlling operation of the ventilation unit when the toga/hood is not coupled to the helmet is important for preventing contamination of the surgical space. Therefore, a personal protection system including an improved fastener for coupling the surgical garment to a helmet could improve the performance of the personal protection system.

### SUMMARY

The present disclosure relates generally to a surgical garment. The surgical garment comprises an assembly including a shield that may be configured for attachment to a surgical helmet, wherein the surgical garment including a shield can be employed to provide a barrier between an individual wearing the system and the surrounding environment.

In an exemplary configuration, a general aspect includes a method of controlling ventilation assembly of a surgical helmet. The method of controlling ventilation assembly also includes connecting a power source to a connector of the surgical helmet. The assembly also includes automatically actuating a ventilation assembly of the surgical helmet upon connecting the power source to the connector of the surgical helmet; pausing actuation of the ventilation assembly based on receipt of a user input signal from a user input device coupled to the surgical helmet, disposing a surgical garment over the surgical helmet after pausing the actuation of the ventilation assembly, coupling the surgical garment to the surgical helmet, automatically resuming actuation of the ventilation assembly when the surgical garment is coupled to the surgical helmet.

In another exemplary configuration, a general aspect includes a surgical helmet for use with a surgical garment and a power source. The surgical helmet also includes a helmet base. The helmet also includes a sensor configured to detect a presence of the surgical garment; a ventilation assembly coupled to said helmet base, a controller electrically connected to said ventilation assembly and configured to control operation of said ventilation assembly. The helmet also includes a user input device coupled to said surgical helmet and in communication with said controller, said user input device being manipulatable by a user. The helmet also includes where said controller is configured to automatically actuate said ventilation assembly when the power source is connected to said surgical helmet, to manually deactivate said ventilation assembly when the user manipulates said user input device, and to automatically re-actuate said ventilation assembly when said sensor detects the presence of the surgical garment.

In yet another exemplary configuration, a protective apparel system configured for use with a helmet may provide a barrier between an environment and a wearer. The helmet may include a protrusion at least partially disposed within an alignment channel, and a chin bar. The chin bar may include at least two magnetic coupling members. The protective apparel system may comprise a surgical garment including a shell configured to be at least partially disposed over the helmet. The shell may comprise an opening configured to be positioned forward of the wearer's face when at least partially disposed over the helmet. The protective apparel system may further comprise a transparent face shield disposed within the opening of the shell. The transparent face shield may comprise a first surface and an opposing second surface, and an upper portion and a lower portion. The protective apparel system may further comprise a tab on the wearer side of said shell, the tab having outer edges for aligning the shell relative to the helmet via the alignment channel of the helmet. The protective apparel system may further comprise a first aperture at least partially formed in said tab and configured to removably engage the protrusion of the helmet to align the shell relative to the helmet. The protective apparel system may further comprise a first attachment element and a second attachment element, the first and second attachment elements being secured to said lower portion of said transparent face shield on opposing lateral sides of said first aperture of the tab. Each of the first and second attachment elements may comprise a retention feature, the retention feature being positioned closer to the second surface of the transparent face shield than the first surface. The first and second attachment elements may comprise a ferromagnetic material and define a respective coupling recess on said wearer side of said barrier. First and second attachment elements and/or the coupling recess are configured to removably engage the magnetic coupling members on the helmet.

In another exemplary configuration, a surgical garment assembly may be configured for use with a surgical helmet comprising a magnetic coupling member disposed in a recess and a hall-effect sensor spaced from the coupling member. The surgical garment assembly may be configured to be at least partially disposed over the surgical helmet to provide a microbial barrier between the user and a medical environment. The surgical garment assembly may comprise a surgical fabric defining an opening and a transparent face shield disposed within the opening. The transparent face shield may comprise an upper portion, a lower portion, a first surface and an opposing second surface. A first attachment element may be coupled to the lower portion of the transparent face shield. The first attachment element may comprise a cylindrical head including a distal end and an opposing proximal end. The proximal end may define a proximal surface facing away from the transparent face shield. The proximal surface may include a first portion angularly extending in a proximal direction from a medial plane of the cylindrical head to a first edge. A second portion may angularly extend in the proximal direction from the medial plane of the cylindrical head to a second edge. The cylindrical head comprises a ferromagnetic material, and the first attachment element may be configured to removably engage the coupling member on the surgical helmet and trigger the hall-effect sensor when the first attachment element is coupled to the coupling member.

In yet another exemplary configuration, a surgical garment assembly may be configured for use with a surgical helmet comprising a magnetic coupling member disposed in a recess and a hall-effect sensor spaced from the coupling member. The surgical garment assembly may be configured to be at least partially disposed over the surgical helmet to provide a microbial barrier between the user and a medical environment. The surgical garment assembly may comprise a surgical fabric defining an opening and a transparent face shield disposed within the opening. The transparent face shield may comprise an upper portion, a lower portion, a first surface and an opposing second surface. A first attachment element may be coupled to said lower portion of said transparent face shield. The first attachment element may comprise a cylindrical head including a distal end and an opposing proximal end. The cylindrical head may comprise a ferromagnetic material, and the first attachment element may be configured to removably engage the coupling member on the surgical helmet and trigger the hall-effect sensor when the first attachment element is coupled to the coupling member.

In yet another exemplary configuration, a surgical garment assembly may be configured for use with a surgical helmet comprising a magnetic coupling member disposed in a recess and a hall-effect sensor spaced from the coupling member. The surgical garment assembly may be configured to be at least partially disposed over the surgical helmet to provide a microbial barrier between the user and a medical environment. The surgical garment assembly may comprise a surgical fabric defining an opening and a transparent face shield disposed within the opening. The transparent face shield may comprise an upper portion, a lower portion, a first surface and an opposing second surface. A first attachment element may be coupled to said lower portion of said transparent face shield. The first attachment element may be configured to removably engage the coupling member on the surgical helmet and trigger the hall-effect sensor when said first attachment element is coupled to the coupling member.

These and other configurations, features, and advantages of the present disclosure will be apparent to those skilled in the art. The present disclosure is not intended to be limited to or by these configurations, embodiments, features, and/or advantages.

### BRIEF DESCRIPTION OF THE DRAWINGS

Referring now to the drawings, exemplary illustrations are shown in detail. Although the drawings represent schematic embodiments and/or exemplary configurations, the drawings are not necessarily to scale and certain features may be exaggerated to better illustrate and explain an innovative aspect of an exemplary configuration. Furthermore, the exemplary illustrations described herein are not intended to be exhaustive or otherwise limiting or restricting to the precise form and configuration shown in the drawings and disclosed in the following detailed description.

Advantages of the present disclosure will be readily appreciated as the same becomes better understood by reference to the following detailed description when considered in connection with the accompanying drawings.

FIG. 1 is a perspective view of a first configuration of a surgical apparel system that includes a surgical garment and a surgical helmet, with the surgical helmet shown in phantom.

FIG. 2 is a perspective view of the surgical garment of the surgical apparel system of FIG. 1.

FIG. 3A is a front perspective view of the surgical helmet of the surgical apparel system of FIG. 1.

FIG. 3B is a rear perspective view of the surgical helmet of the surgical apparel system of FIG. 1.

FIG. 4 is a front perspective view of a coupling member of the surgical helmet of FIGS. 3A and 3B, including a detector positioned adjacent the coupling member shown in phantom.

FIG. 5 is a rear perspective view of a coupling member of the surgical helmet of FIGS. 3A and 3B, including a detector positioned adjacent the coupling member.

FIG. 6 is a rear perspective view of a chin bar of the surgical helmet of FIGS. 3A and 3B, the chin bar including buttons for controlling operation of a peripheral device of the surgical helmet.

### DETAILED DESCRIPTION

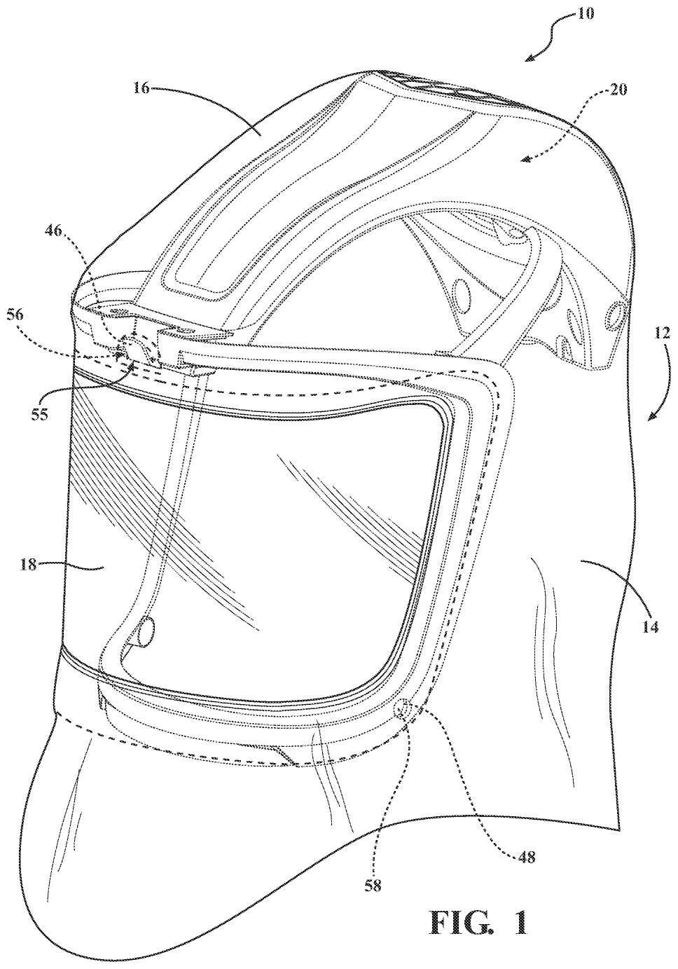

Maintaining a reliable barrier between a healthcare provider and a patient to prevent the exchange and/or transfer of particles or foreign material during a medical procedure or examination is of the utmost importance. During medical and surgical procedures, a healthcare provider may wear an assembly known as a surgical apparel system, such as the surgical apparel system 10 illustrated in FIG. 1.

Accordingly, the surgical apparel system 10 may comprise a surgical garment assembly comprising a surgical garment 12, which may also be referred to as a surgical garment, configured for attachment to a surgical helmet 20. The surgical garment 12 is configured to provide a barrier, such as a microbial barrier, between the wearer and the surrounding environment. The barrier created by the surgical garment 12 may benefit both the wearer and the patient. The barrier provided by the surgical garment 12 may substantially eliminate the likelihood that the wearer may come into contact with fluid or solid particles of matter from the patient that may be generated during the course of a surgical procedure. The barrier may substantially prevent the transfer of any foreign particles emitted by the wearer from being transferred to the patient during the surgical procedure.

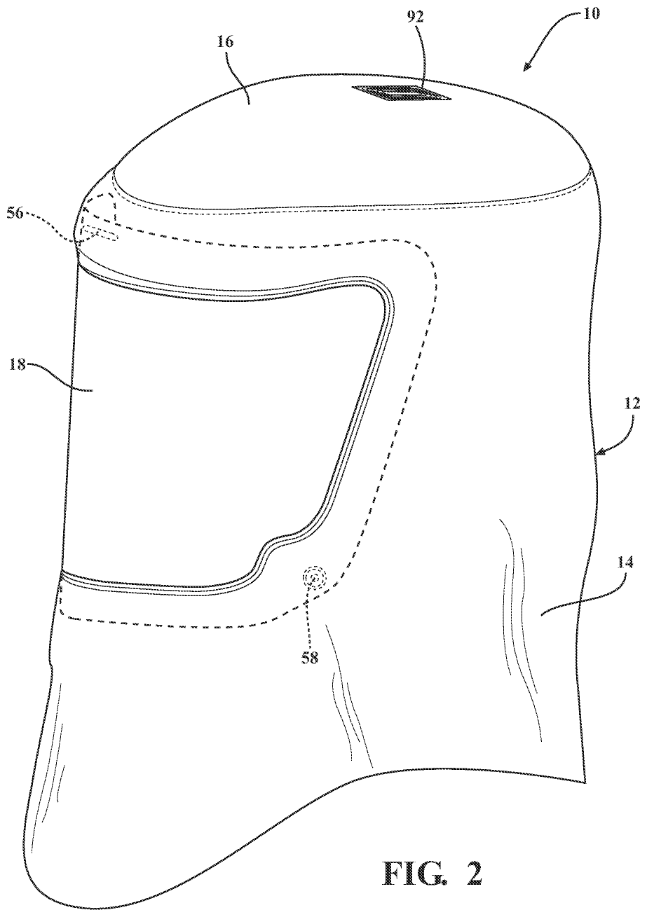

Referring to FIGS. 1 and 2, the surgical garment 12 may include a surgical fabric 14, which may also be referred to as a shell, configured to cover the surgical helmet 20 and at least a portion of the head of the wearer. The surgical garment 12 may be configured as a hood, as illustrated in FIGS. 1 and 2. It will be understood that a hood refers to a surgical garment 12 that covers the head and likely only extends a short distance below the neck when worn by the wearer. However, while not illustrated in the figures, it is further contemplated that the surgical garment 12 may be configured as a toga, a shirt, or a jacket. It will be understood that a toga 12 refers to a surgical garment 12 that covers the head in the same manner as a hood and extends to at least the waist when worn by the wearer.

The surgical garment 12 may be manufactured from any suitable surgical fabric 14 or combinations of fabrics to help repel and/or absorb water, debris and other contaminants. The surgical fabric 14 may include multiple layers. One such layer may be a microporous film that allows gas to pass through the fabric while still maintaining the microbial barrier. In certain configurations, the surgical fabric 14 is one that satisfies the ASTM F170-98 standard for blood penetration resistance and/or the ASTM F1671-97B standard for viral penetration resistance. In one non-limiting example of the surgical fabric 14, the surgical fabric 14 of the surgical garment 12 has a pore size in the approximate range of 0.5 to 0.20 microns. However, other pore sizes for the surgical fabric 14 are also contemplated.

It is further contemplated that the surgical garment 12 may be constructed of multiple different fabrics coupled to one another to define the barrier. For example, the surgical garment 12 may be primarily constructed from a barrier surgical fabric 14 and a filter fabric 16. The filter fabric 16 may be more permeable, and hence more breathable, than the barrier surgical fabric 14 described above. The filter fabric 16 may be located in an area with a reduced risk of having a microbial particle cross the barrier, such as above the wearer's head or proximate to the crown of the wearer's head, and configured to aid in the circulation of air through the barrier. The barrier surgical fabric 14 may be attached to the filter fabric 16 using any suitable means, such as adhesive, sewing, welding, or a combination thereof.

As illustrated in FIGS. 1 and 2, the surgical garment 12 may further comprise a face shield 18. The face shield 18 portion of the surgical garment 12 allows the wearer to see through the barrier provided by the surgical garment 12. The face shield 18 is generally a sheet-like structure and may have a thickness of approximately 1 mm or less. The face shield 18 may be mounted and/or attached to an opening or cut-out formed in the surgical fabric 14 of the surgical garment 12. The surgical fabric 14 may be attached around the periphery or edge of the face shield 18 by sewing, snaps, hook and loop, adhesive, welding, or combinations thereof. The face shield 18 may be constructed from a transparent material, such as a polycarbonate. One such polycarbonate is sold under the trademark LEXAN™ by Sabic. The face shield 18 of the surgical garment 12 may also be tinted to protect the wearer's eyes from heightened exposure to bright lights. Furthermore, the face shield 18 may be flexible such that the face shield 18 may be curved to accommodate different head sizes as will be described below.

The face shield 18 may further comprise an opening 56 proximate to the top portion of the face shield 18. The opening 56 may be generally rectangular shaped. While not illustrated in the figures, it is further contemplated that the opening 56 may be configured in the shape of a circle, oval, square, or any similar polygonal shape. The opening 56 may also be generally centered between the opposing ends of the face shield 18 and serve as an alignment element and/or centering feature. Furthermore, the opening 56 may be positioned on the face shield 18 above the point of attachment for the surgical fabric 14 to the face shield 18, so as to ensure the surgical fabric 14 covers the opening 56 to maintain the barrier provided by the surgical garment 12 between the wearer and the environment. For example, as illustrated in FIG. 1, the surgical fabric 14 of the surgical garment 12 is attached to the top of the face shield 18 at a location below the opening 56 of the face shield 18.

The surgical garment 12 may also comprise a tab 55. The tab 55 may be disposed on the wearer side or interior of the surgical garment 12. As illustrated in FIG. 1, the tab 55 may be formed as a portion of the face shield 18. The tab 55 may also define at least a portion of the opening 56, with a portion of the opening 56 also being defined by the face shield 18. It is also contemplated that the opening 56 may be entirely formed or defined within the tab 55

The surgical garment 12 may also include one or more attachment elements 58 positioned about the surgical garment 12. The attachment elements 58 may also be referred to as a garment fastener or a second member. The attachment elements 58 are configured to releasably secure the surgical garment 12 to the surgical helmet 20. The attachment elements 58 may take any suitable form, and may comprise metal tacks, rivets, buttons, magnets, hook and loop, snaps, or similar types of fasteners, alone or in combination. As illustrated in FIG. 1, the attachment elements 58 may be mounted to the face shield 18 of the surgical garment 12 so as to extend inwardly from the wearer side of the face shield 18. While not illustrated in the figures, it is also contemplated that the attachment elements 58 may be positioned at any other position or location about the surgical garment 12, including being mounted to the barrier surgical fabric 14 and/or the filtration fabric 16. The attachment elements 58 may be mounted to the face shield 18 and/or fabric(s) 14/16 via an adhesive, rivet, snap, similar mounting device, or combination thereof.

Referring again to FIGS. 1 and 2, an example configuration of the surgical apparel system 10 is described in detail. The system may include a surgical garment 12 and a surgical helmet 20. The surgical garment 12 may be configured as a hood or a toga to be placed over the surgical helmet 20. In the hood configuration illustrated in FIG. 1, the surgical garment 12 may be positioned over the surgical helmet 20 and configured to encompass the surgical helmet 20 and, correspondingly, the head of the person wearing the surgical apparel system 10, thereby covering the wearer's face and back of the head. Alternatively, if the surgical garment 12 were configured as a toga, the toga may be positioned over the surgical helmet 20 and configured to encompass the surgical helmet 20 and, correspondingly, the head, arms, shoulders, and torso of the person wearing the surgical apparel system 10. To place the surgical garment 12 over the surgical helmet 20, the surgical garment 12 will typically be turned inside out as the face shield 18 is aligned and affixed to the surgical helmet 20 in the manner described below. Once the face shield 18 is positioned relative to the surgical helmet 20, the remainder of the surgical fabric 14 will typically be pulled over the wearer's head to cover the exposed components of the surgical helmet 20 and the wearer's head.

The system 10 may further comprise an electromagnetic tag 92 attached to the surgical garment 12. For example, the electromagnetic tag 92 may comprise an RFID tag, or similar tag configured to contain identification information related to the particular surgical garment 12. The electromagnetic tag 92 may be positioned anywhere on the surgical garment 12. For example, the electromagnetic tag 92 may be attached to the filter fabric 16 of the surgical garment 12. Alternatively, the electromagnetic tag 92 may be attached to the surgical fabric 14 of the surgical garment 12 or may be attached to the face shield 18 of the surgical garment 12. In one configuration, the tag 92 may be attached to the surgical garment 12 on the wearer side to reduce the likelihood of introducing a non-sterile or contaminated item on the environment side of the barrier defined by the surgical garment 12. Alternatively, it is also contemplated that the tag 92 may be attached to the surgical garment 12 on the environment side of the barrier defined by the surgical garment 12.

The electromagnetic tag 92 may be configured to transmit or otherwise convey information to the surgical helmet 20, including information related to the particular surgical garment 12. As discussed above, the electromagnetic tag 92 may be configured to store data and/or an identifier related to the surgical garment 12, such as a serial number identifying the particular surgical garment 12. The electromagnetic tag 92 may also be configured to store information identifying the type of surgical garment 12 associated with the electromagnetic tag 92. The electromagnetic tag 92 may also store data regarding operational parameters for the surgical helmet 20 that are tailored to the characteristics of the particular surgical garment 12 attached to the surgical helmet 20, such as the size of the surgical garment 12, the type of fabric, whether the surgical garment 12 is a hood or a toga, etc.

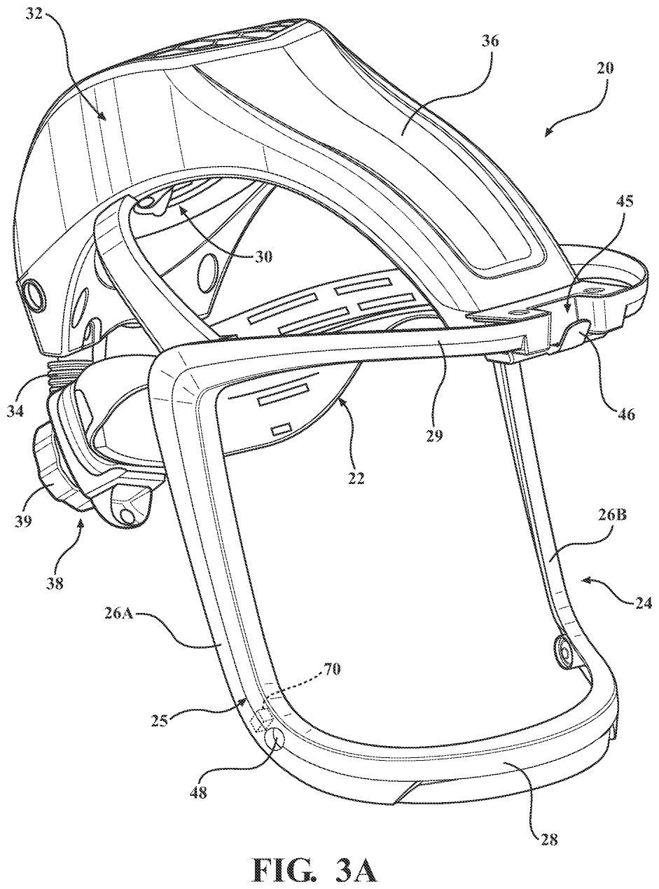

Referring to FIGS. 3A and 3B, an exemplary configuration of the surgical helmet 20 that may be utilized as part of the surgical apparel system 10 is illustrated. The surgical helmet 20 in FIG. 3 includes a headband 22. The headband 22 may be configured to encircle the wearer's head and support the surgical helmet 20. The headband 22 may be constructed from a generally flexible or pliable material, allowing the headband 22 to conform to general shape of the wearer's head. The headband 22 may comprise a headband control assembly 38 configured to adjust the size/shape of the headband 22. The headband control assembly 38 may comprise a control member 39 that is manipulatable by the wearer to adjust the size of the headband 22. For example, as illustrated in FIG. 2, the control member 39 may comprise a rotatable knob or lever. When the wearer rotates the control member 39 in one direction, the headband control assembly 38 may be configured to reduce the size, i.e., the circumference, of the headband 22. Alternatively, when the wearer rotates the control member 39 in the opposite direction, the headband control assembly 38 may be configured to increase the size, i.e., the circumference, of the headband 22. This allows for the headband 22 of the surgical helmet 20 to be adjusted and/or customized to securely fit on a particular individual's head irrespective of the individual's head size and/or shape.

The surgical helmet 20 further includes a housing 32 that is supported by and located above the headband 22. The housing 32 may be configured in an arcuate shape to fit over the head of the individual wearing the personal protection system 10. Other helmet designs are contemplated. Many portions of the housing 32 may be formed to define voids, or open interior spaces. For example, the housing 32 may comprise a center void. The center void may be located toward the rear of the housing 32. There may be an intake opening or aperture in the top portion of the housing 32 to provide access to the center void. The housing 32 may also include additional voids, such as a front void proximate to the front of the housing 32 and a rear void proximate to the rear of the housing 32. The additional voids may be configured to form duct-like structures or passageways within the housing 32. The additional voids may even be interconnected to the center void.

The surgical helmet 20 may include one or more electrically-powered peripheral devices 30, including but not limited to, a ventilation assembly, a light, a camera, microphone or other communication device, cooling device, or combinations thereof. These devices may be mounted to and/or attached at various locations and orientations relative to the surgical helmet 20. Each of the peripheral devices 30 may be configured to receive commands that affect the operating state of the corresponding peripheral device. For example, each of the peripheral devices 30 can receive on/off commands. Alternatively, the peripheral devices 30 may receive commands that change one or more settings of the peripheral devices 30. Such configurations allow the wearer of the surgical helmet 20 to control the operating state of the various peripheral devices 30 during the surgical procedure. In one specific example, when the peripheral device is a ventilation assembly 30, the ventilation assembly 30 may be configured to receive various commands to control the actuation and/or adjust the speed of the fan in the ventilation assembly 30. Alternatively, when the peripheral device is a cooling device 30, the cooling device 30 may be configured to receive commands to control the intensity of the cooling output provided by the cooling strip. When the peripheral device is a microphone 30, the microphone 30 may be configured to receive commands to control the volume of the audible signal produced by the microphone. When the peripheral device is a light 30, the light 30 may be configured to receive commands to control the direction and/or intensity of light emitted. The peripheral devices 30 may of course be configured to be responsive to other types of commands that control the operation of the peripheral device 30.

Wearing the surgical apparel system 10, including the surgical garment 12, over a wearer's head can inevitably result in the buildup of carbon dioxide and increased temperatures within the surgical garment 12 as a result of the wearer's normal breathing. An increase in temperature underneath the surgical garment 12 can also result in the buildup of water vapor on the wearer and/or the face shield 18, resulting in the wearer's view being obstructed. In order to prevent these undesirable effects, the surgical helmet 20 of the surgical apparel system 10 may be configured for the attachment and/or inclusion of one or more peripheral devices 30 described above, such as the ventilation assembly, the cooling device, etc. Certain features of the surgical helmet 20, the peripheral devices 20, and the surgical garments 12 may be found in one or more of the following U.S. patents, which are hereby incorporated by reference: U.S. Pat. Nos. 6,481,19; 6,622,311; 6,973,677; 7,735,156; 7,752,682; 8,234,722; 8,282,234; 8,407,818; 8,819,869; and 9,173,437.

The ventilation assembly 30 of the surgical helmet illustrated in FIGS. 3A and 3B is one example of a peripheral device 30 that may be incorporated into the surgical helmet 20 of the surgical apparel system 10. While the ventilation assembly 30 is shown as an integral component of the surgical helmet 20, it should be appreciated that each of the other peripheral devices 30 described above may be either an integral component of the surgical helmet 20, or may be removably coupled to the surgical helmet 20. The surgical helmet 20 illustrated in FIGS. 3A and 3B comprises the ventilation assembly 30 positioned within the center void of the housing 32. The ventilation assembly 30 may include a fan blade, impeller, propeller, fan wheel, or similar blade mechanism configured to induce air movement. The blade may be coupled to a motor configured to rotate the blade when energized by a power source. When the blade is actuated, the ventilation assembly 30 is configured to draw air into the center void of the housing 32 through the intake opening in the top of the housing 32. The additional voids of the housing 32 may be connected to the center void and serve as ducts for dispersing the air drawn into the center void.

The exemplary ventilation assembly 30 may include a front bellows 36 that extends forward from the front void in the front of the housing 32 and connects to a front nozzle 40. The front nozzle 40 may be mounted to the front of the headband 22. The ventilation assembly 30 may further include a rear bellows 34 that extends from the rear void in the rear of the housing 32 to a rear nozzle (not shown in figures). The rear nozzle may be mounted to the back of the headband 22. When the ventilation assembly 30 of the surgical helmet 20 is actuated, the fan draws air in through the surgical garment 12 into the opening in the top of the housing 32 and disperses the air outward through the additional voids. For example, the ventilation assembly 30 may be configured to draw air through the filter fabric 16 of the surgical garment 12. The air is then discharged through front bellows 36 and rear bellows 34, respectively. The air that flows through the front bellows 36 is discharged through the front nozzle 40 in front of the face of the wearer. The air discharged through the front nozzle 40 may be discharged against the face shield 18 and/or on the face of the wearer. The air that flows through the rear bellows 34 is discharged through the rear nozzle. The rear nozzle is positioned so as to open below the headband 22. The air discharged from the rear nozzle can be discharged against the back of the neck of the wearer.

The surgical helmet 20 may comprise a top beam 29 positioned forward of the housing 32 of the surgical helmet 20 and configured to extend across the front of the surgical helmet 20. The top beam 29 may further comprise a recess. The recess of the top beam 29 may comprise a pair of laterally spaced-apart side walls 39A, 39B, and a proximal surface that is positioned proximally from the distal surface of the top beam 29. The side walls 39A, 39B, and the proximal surface 37 may define an alignment channel 45, wherein the alignment channel 45 is configured to receive a tab 55 disposed on the interior of the surgical garment 12 to align and/or orient the surgical garment 12 relative to the surgical helmet 20. As described above, the tab 55 may be integrally formed with and configured to extend from the face shield 18. Alternatively, the tab 55 may be formed independent of the face shield 18, wherein the tab 55 is configured to be coupled to the fabric 14 on the interior of the surgical garment 12. However, other configurations are contemplated. The spaced-apart side walls 39A, 39B of the alignment channel 45 should be spaced apart a distance greater than the width of the tab 55 to allow the tab 55 to be positioned between the spaced-apart side walls 39A, 39B.

The top beam 29 may further comprise a coupling feature 46 configured to removably engage the face shield 18 and/or surgical garment 12. The coupling feature 46 may comprise a protrusion, magnetic member, ferromagnetic member, hook and loop, or similar coupling mechanism configured to releasably engage the opening 56 in the tab 55 to align and/or couple the surgical garment 12 to the surgical helmet 20. For example, as illustrated in Figure, the coupling feature 46 is realized as a protrusion 46 extending from the alignment channel 45 of the top beam 29. Here, the top beam 29 comprises the alignment channel 45 described above, and the coupling feature 46 may be disposed at least partially within the alignment channel 45, as illustrated in FIGS. 3A and 3B. The coupling feature 46 may be positioned within the alignment channel 45 such that the top of the upper most surface coupling feature 46 is arranged or otherwise positioned below the top of the top of the alignment channel 45 and/or the top surface of the top beam 29. The combination of the spaced-apart side walls 39A, 39B of the alignment channel 45 coupling feature 46 may serve to align and/or orient the face shield 18 and/or the surgical garment 12 relative to the surgical helmet 20. More specifically, the spaced-apart side walls 39A, 39B of the alignment channel 45 may serve to guide the tab 55A, 55B such that the opening 56 in the tab 55 is directed into engagement with the coupling feature 46 as the surgical garment 12 is placed over the surgical helmet 20.

The surgical helmet 20 may include a chin bar 24 that extends downwardly from the front portion of the surgical helmet 20. The chin bar 24 may comprise a first post 26A and a second post 26B. The first and second posts 26A, 26B may be coupled to the top beam 29, wherein the top beam 629 is configured to extend across the front of the surgical helmet 20. For example, as illustrated in FIG. 3A, the first and second posts 26A, 26B may be connected to opposing ends of the top beam 29. The chin bar 24 may be constructed from a generally flexible or pliable material.

The chin bar 24 may further comprise a bottom beam 28 that may extend between the opposed free ends of the posts 26A, 26B. The chin bar 24 is formed so that the bottom beam 28 is located below and slightly forward of the chin of the person wearing the surgical helmet 20. The bottom beam 28 may be bowed outwardly from the free ends of posts 26A, 26B. The chin bar 24 may extend outwardly from the top beam 29 such that the chin bar 24 is positioned forward of and generally encircles the face of the wearer when the surgical helmet 20 is secured to the wearer's head. Collectively, the combination of the top beam 29, the posts 26A, 26B, and the bottom beam 28 may be referred to as the face frame, as they generally define an opening positioned in front of the wearer's face when the surgical helmet is positioned on top of the wearer's head.

A plurality of coupling members 48 may be mounted to or within the chin bar 24. The coupling members 48 comprise magnetic material and are configured to align and/or attach the face shield 18 of the surgical garment 12 to the surgical helmet 20. Each coupling member 48 may be positioned on the chin bar 24 proximate to the opposed posts 26A, 26B and/or adjacent opposing ends of the bottom beam 28. Alternatively, the coupling members 48 of the surgical helmet 20 could be arranged or otherwise configured in any suitable way to cooperate with the complementary attachment elements 58 of surgical garment 12 to releasably secure the surgical garment 12 to the surgical helmet 20. For example, as illustrated in FIG. 14, the coupling member 48 may be positioned on the chin bar 24 at opposing ends of the bottom beam 28 proximate where each of the posts 26A, 26B connects to the bottom beam 28. While the exemplary configuration of the surgical helmet 20 illustrated in FIG. 14 utilizes two coupling members 48, it is contemplated that the surgical helmet 20 may be configured such that the chin bar 24 comprises a single coupling member 48 or, in other configurations, three or more coupling members 48 may be spaced about the chin bar 24 and/or top beam 29. It is contemplated that other types of coupling members 48 may be used in place of and/or in addition to those comprising magnetic materials, such as with a hook and loop fasteners, snaps, coupling members comprising ferromagnetic material, or similar type fasteners. Other configurations are contemplated.

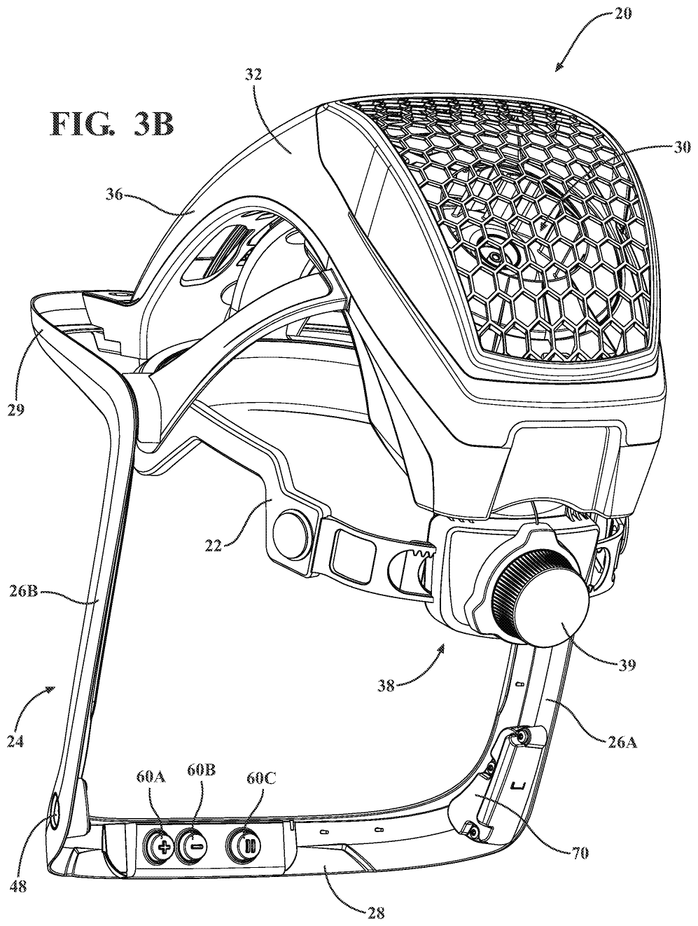

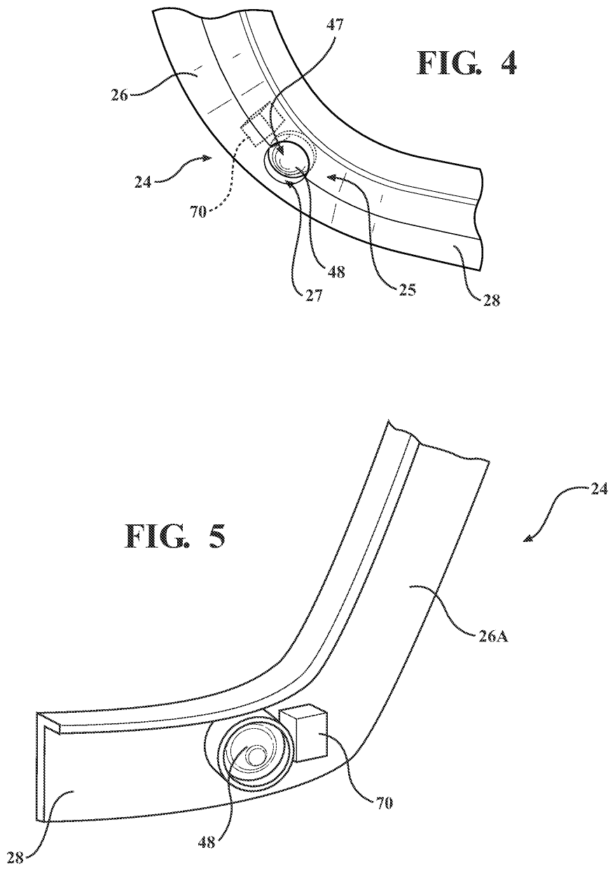

Referring to FIGS. 4 and 5, an exemplary configuration of a coupling member 48 positioned within the chin bar 24 is illustrated. The coupling member 48 may comprise a distal surface 47. The chin bar 24 may comprise a recess 27 configured to receive the coupling feature 48. For example, as illustrated in FIG. 4, the coupling member 48 may be positioned within the recess of the chin bar 24, such that the distal surface 47 of the coupling member 48 is positioned proximally to a distal surface 25 of the chin bar 24.

The coupling member 48 may comprise one of a ferromagnetic material or a magnetic material. This may include the coupling member 48 being formed of or constructed from a ferromagnetic material or a magnetic material. It is also contemplated that only a portion of the coupling member 48 comprises a ferromagnetic material or a magnetic material. For example, the coupling member 48 may be injection-molded plastic and coated with a ferromagnetic material or magnetic material. Alternatively, the coupling member 48 may be formed from a ferromagnetic material or magnetic material, and then coated with a plastic or similar coating to provide a sterile and/or wear-resistant surface. It is also contemplated that a magnet may be “over-molded” with plastic material to define the coupling member 48. Generally, the coupling member 48 may comprise the other of the ferromagnetic material or magnetic material relative to the attachment element(s) 58 of the surgical garment 12 in order to create a magnetic attraction between the coupling member(s) 48 and the attachment element(s) 58 to couple the surgical garment 12 to the surgical helmet 20.

To couple the surgical garment 12 to the surgical helmet 20 when the tab 55 is formed as part of the face shield 18, the face shield 18 may be positioned with the opening 56 in the tab 55 above the alignment channel 45 and the protrusion 46. The tab 55, and by extension the face shield 18, may then be lowered onto the surgical helmet 20 such that at least a portion of the tab 55 is positioned within the alignment channel 45 between the pair of laterally spaced-apart side walls 39A, 39B. The tab 55 should be positioned within the alignment channel 45 such that the protrusion 46 is disposed within the opening 56 of the tab 55. The lower portion of the face shield 1A, that includes the attachment elements 58, may then be manipulated to couple the attachment elements 58 to the complementary coupling members 48 positioned on the chin bar 24. For example, once the tab 55 is positioned within the alignment channel 645 and the protrusion 46 is disposed within the opening 56 of the tab 55, the face shield 18 may be pivoted about the protrusion 46 to position the attachment elements 58 adjacent to the complementary coupling members 48. This is one example of a method of coupling the surgical garment 12 to the surgical helmet.

In operation, once the opening 56 in the face shield 18 is seated on the protrusion 46 of the surgical helmet 20, the face shield 18 may then be flexed around the surgical helmet 20 and/or chin bar 24 to matingly engage the attachment elements 58 spaced about the periphery of the face shield 18 with the complementary coupling members 48 on the chin bar 24 of the surgical helmet 20. The size of the face shield 18, as well as the spacing and/or position of the attachment elements 58 on the surgical garment 12 may be changed to alter the curvature and/or shape of the face shield 18 when attached to the surgical helmet 20. For example, the attachment elements 58 on the surgical garment 12 may be spaced closer together to reduce the curvature of the face shield 18 when it is attached to the surgical helmet 20. Alternatively, the attachment elements 58 on the surgical garment 12 may be spaced farther apart to increase the curvature of the face shield 18 when it is attached to the surgical helmet 20. Furthermore, as illustrated in FIG. 4, the coupling member 48 of the chin bar 24 may be part of a protrusion 47 configured to space the face shield 18 a defined distance from the chin bar 24 and/or surgical helmet 20. The size of the protrusion 47 may be similarly adapted to manipulate the curvature or arc of the face shield 18. Altering the curvature of the face shield 18 may help to reduce glare or provide an expanded/reduced peripheral view through the face shield 18. While not illustrated in the figures, it should be understood that alternative configurations for securing the surgical garment 12 and/or face shield 18 to the surgical helmet 20 are also contemplated. For example, in one alternative configuration, the face shield 18 may not include a rectangular opening 56, but instead comprise only a plurality of attachment elements 58, such as rivets or magnets, spaced about the face shield 18 and/or surgical garment 12 and configured to couple to complementary magnets or similar coupling members 48 spaced about the surgical helmet 20. For example, the complementary magnets or similar coupling members 48 may be secured to the housing 32, headband 22, and/or chin bar 24. The surgical garment 12 and the surgical helmet 20 of the surgical apparel system 10 described above are typically removably coupled to allow for disposal of the surgical garment 12 and reuse of the surgical helmet 20 following a procedure or exam.

The surgical helmet 20 may further comprise a controller or processor (not illustrated), which may be disposed on or within the chin bar 24 or top beam 29 of the surgical helmet 20. Alternatively, the controller may be positioned at any suitable location within the surgical helmet 20. For example, the controller may be positioned in the bottom beam 28 of the chin bar 24. The controller may be in communication with the one or more detectors 70, such as a Hall-effect sensor, that is positioned within the chin bar 24 and adjacent to the coupling member 48. The detector 70 may be configured to detect a characteristic of the coupling member 48. For example, wherein the detector 70 is a Hall-effect sensor, the detector 70 may be configured to detect any changes to the magnetic field surrounding the coupling member 48. In operation, the detector 70 may be configured to detect a change in the magnetic field surrounding the coupling member 48 created by the presence or absence of an attachment element 58 of the surgical garment 12 being positioned adjacent the coupling member 48. An exemplary surgical apparel system including a detector is described in International Publication WO2019147923 and International Application No. PCT/US2020/044216, both of which are incorporated herein in their entirety.

The detector 70, as illustrated in FIG. 40, may be positioned adjacent to the coupling member 48. The detector 70 may comprise a Hall-effect sensor configured to detect the change in the magnetic field, indicating the surgical garment 12 is coupled to the surgical helmet 20. For example, when the coupling member 48 comprises the magnetic material and the attachment element 58 comprises the ferromagnetic material, the detector 70 may detect a first level of the magnetic field surrounding the coupling member 48 when the attachment element 58 is separated from the coupling member 48. The detector 70 may then detect a second level of the magnetic field surrounding the coupling member 48 when the attachment element 58 is adjacent to the coupling member 48, indicating the surgical garment 12 is coupled to the surgical helmet 20. Alternatively, wherein the coupling member 48 comprises the ferromagnetic material and the attachment element 58 comprises the magnetic material, the detector 70 may detect the absence of the magnetic field surrounding the coupling member 48 when the attachment element 58 is separated from the coupling member 48. The detector 70 may then detect the presence of the magnetic field when the attachment element 58 is adjacent to the coupling member 48, indicating the surgical garment 12 is coupled to the surgical helmet 20. As described above, the controller may be configured to communicate operational commands to the detector 70 as well as be configured to receive a signal from the detector 70 related to a characteristic detected by the detector 70. The signal may be based on the presence of, absence of, and/or changes in the characteristic to be detected by the detector 70, which may be related to the presence or absence of the surgical garment 12 being coupled to the surgical helmet 20. The controller may also be connected to the one or more peripheral devices 30 of the surgical helmet 20, such as the ventilation assembly 30, wherein the controller is configured to communicate operational commands to and from the ventilation assembly 30, or other peripheral device 30 based on the signal received from the detector 70. For example, the controller may be configured to adjust the amount of power/voltage/current transmitted to the ventilation system 30 to control the speed of the fan blade.

While FIGS. 4 and 5 illustrate only a portion of the chin bar 24 including a single coupling member 48, as discussed above, the chin bar 24 may comprise more than one coupling member 48. Similarly, the chin bar may comprise more than one detector 70. It is contemplated that the surgical helmet 20 may comprise a single detector 70 positioned adjacent to a single coupling member 48. It is also contemplated that in configurations of the surgical helmet 20 that include multiple coupling members 48, the surgical helmet 20 may comprise a single detector 70 positioned adjacent to one of the multiple coupling members 48. Alternatively, detectors 70 may be placed adjacent to two or more of the coupling members 48. Use of multiple detectors may provide redundancy in the event a detector 70 is damaged.

Other configurations of the system 10 may have different sub-assemblies for ensuring that only when the surgical garment 12 is fitted to the surgical helmet 20, the peripheral device(s) 30, such as the ventilation assembly, may be actuated. For example, it should be understood that the surgical helmet 20 may comprise additional and/or alternative garment detectors, in addition to the detectors 70 described above. The garment detector may comprise a pressure sensor, a load sensor, or similar type of sensor configured to detect the attachment of the surgical garment 12 to the surgical helmet 20. For example, the chin bar 24 may comprise a garment detector in the form of a pressure sensor configured to detect the attachment of the surgical garment 12 to the surgical helmet 20. It is also contemplated that the detector 70 may be configured as a reader, such as an electromagnetic tag reader of RFID reader configured to detect and/or communicate with an electromagnetic tag 92 disposed on the gown. The detector 70 may configured to determine the presence or absence of a surgical garment 12 being disposed over the surgical helmet 20 based on communication, or the lack of communication, with the electromagnetic tag 92 on the surgical garment 12.

Additional exemplary configurations of the detector for determining the present or absence of the surgical garment being coupled to the surgical helmet 20:

For example, in operation, the wearer may place the surgical helmet 20 including a peripheral device 30, such as a ventilation assembly, on their head and attach an energy source to the surgical helmet 20. The controller may then actuate the ventilation assembly 30 to confirm the ventilation assembly 30 is working properly. The controller may then deactivate the ventilation assembly 30. Next, the wearer may attach the surgical garment 12 to the surgical helmet 20. The attachment of the surgical garment 12 to the surgical helmet 20 may be detected by the detector 70, such as a pressure sensor, switch, or transceiver 90 configured to detect the presence of an RFID tag 92 or other electromagnetic tag on the surgical garment 12, or similar detector as described above. The detector 70 may then send a signal to the controller to confirm the surgical garment 12 has been attached to the surgical helmet 20. The controller may then actuate the ventilation assembly 30.

In yet another configuration of the system 10, the surgical garment 12 and surgical helmet 20 may each comprise complementary conductors. When the surgical garment 12 is fitted to the surgical helmet 20, a conductor integral with the surgical garment 12 closes the connection between the surgical garment 12 and the surgical helmet 20. For example, the conductor of the surgical garment 12 may be integrally formed with the face shield 18 and the complementary conductor may be included in the chin bar 24, such that the circuit becomes closed once the conductor of the face shield 18 engages the conductor in the chin bar 24. The conductors may further be in communication with the magnets/ferromagnetic elements of the attachment elements 58 and/or the corresponding coupling members 48 of the chin bar 24. A garment detector may be configured to sense the closing of the circuit between the attachment elements 58 of the face shield 18 and surgical helmet 20. In response to detecting this change in circuit state, the garment detector may generate a signal to the controller indicating that the circuit is in the closed state and ready for actuation. In certain configurations, the controller may only generate operational command signals that result in the actuation of the peripheral device(s) 30 when this signal is received by the controller.

It should be appreciated that in some configurations of the system 10, the removal of the surgical garment 12 from the surgical helmet 20 may result in the reopening of the circuit between the attachment elements 58 of the surgical garment 12 and the surgical helmet 20, respectively. The garment detector, in response to the detection of the reopening of this circuit may generate a signal indicating that the system 10 is in the open state to the controller. The controller, in response to receiving the signal from the garment detector, may be configured to return the peripheral device(s) 30 of the surgical helmet 20 to the off state. Thus, a further feature of these configurations of the system 10 is that, when the surgical garment 12 is removed from the surgical helmet 20 and use of the peripheral device(s) 30, such as the ventilation assembly, is no longer required, the peripheral device(s) 30 are automatically shut off or deactivated. Similar modes of operation are also contemplated with the other garment detector assemblies described above.

In some versions of the surgical apparel system 10, based on whether or not the surgical garment 12 is detected/fitted to the surgical helmet 20 the controller may regulate whether or not other peripheral device(s) 30 are actuated. Thus, the controller may inhibit the actuation of one or more of the light assembly, the communications unit or the cooling strip based on whether or not an appropriate surgical garment 12 is fitted to the surgical helmet 20.

The controller may be configured to communicate operational commands to the detector 70, as well as be configured to receive a signal from the detector 70 related to a characteristic of the signal detected by the detector 70. The controller may also be connected to the one or more peripheral devices 30 of the surgical helmet 20, such as the ventilation assembly 30, wherein the controller is configured to communicate operational commands to and from the ventilation assembly 30, or other peripheral device 30 based on the signal received from the detector 70. For example, the controller may be configured to adjust the amount of power transmitted to the ventilation system 30 to control the speed of the fan blade. It is further contemplated that two separate controllers may also be utilized.

The surgical apparel system 10 described above may further comprise an energy source, such as a battery for powering the one or more peripheral device(s) 30 of the surgical helmet 20 ((not shown). The energy source may be configured to be connected or interconnected with the system 10 and/or the surgical helmet 20. The energy source, such as a battery, may be configured to be portable. The energy source may be rechargeable and/or replaceable, such that the energy source of the system 10 may be exchanged or replaced.

In one configuration, the controller may be configured to interpret the signal(s) received from the detector 70 and control the transmission of energy from the energy source to the peripheral device 30. For example, if the controller determines that, based on the signal received from detector 70 or the absence of a signal from the detector 70, the surgical garment 12 is absent from the surgical helmet 20, the controller may be configured to prevent the transmission of energy from the energy source to the peripheral device 30. One disadvantage of operating the system 10 that is eliminated by this feature is the generation of unnecessary noise that may be produced by the peripheral device(s) 30 when the peripheral device(s) 30 is not serving a useful purpose. A second disadvantage that may be eliminated by preventing the actuation of a peripheral device 30 prior to mounting the surgical garment 12 to the surgical helmet 20 is the drawing down of the charge in the energy source when actuation of the peripheral device 30 is not needed. Alternatively, if the controller determines that, based on the signal received from detector 70 or the absence of a signal from the detector 70, the surgical garment 12 is coupled to the surgical helmet 20, the controller may be configured to allow the transmission of energy to the peripheral device 30. Alternatively still, the controller may control operation of the peripheral device 30 based on the signal received from the detector 70.

As mentioned above, the coupling member 48 comprises one of a ferromagnetic material or a magnetic material and the attachment element 58 comprises the other of the ferromagnetic material or magnetic material, so that the coupling member 48 and the attachment element 58 may be magnetically attracted to one another. In the illustrated configurations, the coupling member 48 may comprise magnetic material, and hence a magnetic field may emanate from or otherwise be generated by the coupling member 48. When the coupling member 48 is coupled to the attachment element 58, the magnetic field surrounding the component comprising the magnetic material will be altered when the component comprising the ferromagnetic material is placed adjacent to it.

The detector 70 positioned adjacent to the coupling member 48 may comprise a Hall-effect sensor configured to detect the change in the magnetic field, indicating the surgical garment 12 is coupled to the surgical helmet 20. For example, when the coupling member 48 comprises the magnetic material and the attachment element 58 comprises the ferromagnetic material, the detector 70 may detect a first configuration of the magnetic field surrounding the coupling member 48 when the attachment element 58 is separated from the coupling member 48. The detector 70 may then detect a second configuration of the magnetic field surrounding the coupling member 48 when the attachment element 58 is adjacent to the coupling member 48, indicating the surgical garment 12 is coupled to the surgical helmet 20. Alternatively, wherein the coupling member 48 comprises the ferromagnetic material and the attachment element 58 comprises the magnetic material, the detector 70 may detect the absence of the magnetic field surrounding the coupling member 48 when the attachment element 58 is separated from the coupling member 48. The detector 70 may then detect the presence of the magnetic field when the attachment element 58 is adjacent to the coupling member 48, indicating the surgical garment 12 is coupled to the surgical helmet 20. As described above, the controller may be configured to communicate operational commands to the detector 70 as well as be configured to receive a signal from the detector 70 related to a characteristic detected by the detector 70. The signal may be based on the presence of, absence of, and/or changes in the characteristic to be detected by the detector 70, which may be related to the presence or absence of the surgical garment 12 being coupled to the surgical helmet 20. The controller may also be connected to the one or more peripheral devices 30 of the surgical helmet 20, such as the ventilation assembly 30, wherein the controller is configured to communicate operational commands to and from the ventilation assembly 30, or other peripheral device 30 based on the signal received from the detector 70. For example, the controller may be configured to adjust the amount of power transmitted to the ventilation system 30 to control the speed of the fan blade.

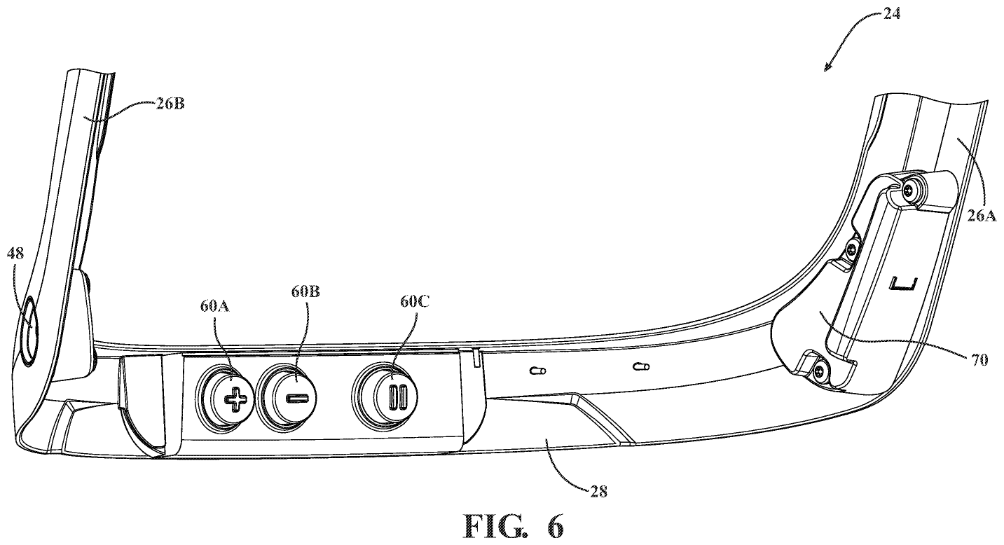

Referring to FIG. 6, the surgical helmet 20 may further comprise a user input device 60. The user input device 60 may comprise a button, knob, switch, or similar device that is manipulatable by the user. The user input device 60 may be disposed on the surgical helmet and configured to communicate with the controller of the surgical helmet 20 for the purpose of controlling the peripheral device 30 of the surgical helmet 20. For example, the user input device 60 may be configured to signal the controller to manipulate the speed of the fan of the ventilation assembly 30 based on manipulation of the user input device 60 by the user. The user input device 60 may also be configured to turn the peripheral device 30 of the surgical helmet 20 on and off. It is further contemplated that the user input device 60 may be configured to control multiple peripheral devices 30. For example, the surgical helmet may comprise two peripheral devices, a such as a ventilation assembly and a light. The user input device 60 may be configured to control both peripheral devices 30.

An exemplary configuration of the surgical helmet 20 comprising a plurality of user inputs 60A, 60B, 60C is illustrated in FIGS. 3B and 6. The surgical helmet 20 may include a first user input device 60A, a second user input device 60B, and a third user input device 60C, each of which is configured to signal to the controller to manipulate a characteristic of the peripheral device 30. For example, the first user input device 60A may configured to signal to the controller to increase the speed of the fan of the ventilation assembly 30 and the second user input device 60B may configured to signal to the controller to decrease the speed of the fan of the ventilation assembly 30. This may be accomplished by the controller increasing or decreasing the voltage and/or current supplied to the ventilation assembly 30 to manipulate the speed of the fan. The third user input device 60C may be configured to start and/or stop the rotation of the fan of the ventilation assembly 30 by signaling to the controller to stop the flow of power from the energy source to the ventilation assembly 30. For example, the controller may be configured to automatically activate the ventilation assembly 30 and actuate the fan upon the energy source being connected to the surgical helmet 20. The user may then manipulate the third user input device 60C to signal to the controller to pause and/or deactivate the ventilation assembly 30. Once paused and/or deactivated, the user may subsequently manipulate the third user input device 60C to signal to the controller to re-activate the ventilation assembly 30. As described above, the user input device may be configured to manipulate multiple peripheral devices 30. For example, if the surgical helmet 20 includes two peripheral devices 30, such as a ventilation assembly and a light, the user may manipulate the user input device 60C to deactivate both the ventilation assembly and the light at the same time. The system 10 may be configured such that the user may manipulate the user input device 60C to similarly re-activate both the ventilation assembly and the light at the same time. While three user inputs 60A, 60B, 60C are illustrated in Figures, any number of user inputs 60 may disposed on the surgical helmet 20. For example, the surgical helmet 20 may comprise an additional user input devices 60 configured to activate and deactivate a peripheral device, such as a light.

It is further contemplated that the controller may be configured to operate the peripheral device 30, such as the ventilation assembly, based on a combination of signals provided by the user input device 60 and/or the detector 70. For example, the controller may be configured to automatically activate the peripheral device 30 upon the energy source being connected to the surgical helmet 20. The controller may be further configured to deactivate the peripheral device after a defined period of time, or upon the controller receiving a signal from the user input device 60. For example, the controller may be configured to automatically activate the peripheral device 30 upon the energy source being connected to the surgical helmet 20, and then deactivate the peripheral device after the passage of a defined period of time, such as five seconds (5-sec.). This may allow the user to confirm that the energy source and the peripheral device 30 of the surgical helmet 20 are operational, before deactivating the peripheral device 30 to prevent unnecessarily draining the energy source when the peripheral device 30 is not needed and/or to prevent the peripheral device 30, such as the ventilation assembly, from circulating the air and potentially causing contaminates to be spread about the surgical space prior to the surgical garment 12 being disposed over the surgical helmet 20.

Alternatively, the controller may be configured to automatically activate the peripheral device 30 upon the energy source being connected to the surgical helmet 20, and then deactivate the peripheral device 30 upon receiving a signal from the user input device 60. For example, the controller may be configured to automatically activate the peripheral device 30 upon the energy source being connected to the surgical helmet 20, and then deactivate the peripheral device 30 after upon the user manipulating a user input device 60 configured to provide a signal to the controller to pause and/or deactivate the peripheral device 30. Again, this may serve to allow the user to confirm that the energy source and the peripheral device 30 of the surgical helmet 20 are operational without unnecessarily draining the energy source and/or from circulating the air and/or contaminates about the surgical space prior to the surgical garment 12 being disposed over the surgical helmet 20.

The controller may then be further configured to re-activate the peripheral device 30 upon receipt of a subsequent signal from one of the user input device 60 and/or the detector 70. For example, once the controller has deactivated the peripheral device 30, the controller may be configured to re-activate the peripheral device 30 upon receiving a subsequent signal from the user input device 60. This may include the user manipulating the user input a second time to signal to the controller to re-activate the peripheral device 30.

It is also contemplated that the detector 70 may be utilized to activate the peripheral device 30. As described above, the detector may be configured to detect the absence and/or presence of the surgical garment 12 being disposed over the surgical helmet 20, and to send a signal to the controller indicative of the absence or presence of the surgical garment 12. The controller may then be configured to controller the energization of the peripheral device 30 based on the detector indicating that the surgical garment 12 is absent or present. For example, once the controller has deactivated the peripheral device 30 after passage of a defined period of time and/or receiving an initial signal from user input device 60, the controller may be configured to prevent re-activation of the peripheral device 30 until the controller receives a signal from the detector 70 indicating the surgical garment 12 is disposed over the surgical helmet 20. Following the initial operation of the peripheral device 30 upon the energy source being connected to the surgical helmet, this may prevent further operation of the peripheral device 30 until the surgical garment 12 is disposed over the surgical helmet 20 (i.e., the surgical garment 12 has been coupled to the surgical helmet 20). As described above, one of the advantages of deactivating the peripheral device 30 when the surgical garment 12 is not disposed over the surgical helmet 20 is to prevent the peripheral device 30 from agitating the air and potentially spreading contaminates about the surgical space.

In operation, the user may connect the energy source to the surgical helmet 20. Upon connection of the energy source, the controller may be configured to automatically activate the peripheral device 30. The user may then manipulate the user input device 60, such as pressing a pause button, to signal to the controller to deactivate the peripheral device 30. While the controller is described as automatically activating the peripheral device 30 upon connection of the energy source, it is also contemplated that the controller may be configured to require additional input from the user to activate the peripheral device 30 after the energy source has been connected to the surgical helmet 20. For example, the controller may be configured to activate the peripheral device 30 after the energy source has been connected and after the user has manipulated the user input device 60 to signal to the controller to activate the peripheral device 30. In this scenario, the user may then manipulate the user input device 60, such as pressing a pause button, a second time to signal to the controller to deactivate the peripheral device 30.

The peripheral device 30 may then be re-activated in one of two ways. The first method of reactivating the peripheral device 30 may comprise the user manipulating the user input device 60 a second time. Alternatively, the peripheral device 30 may be reactivated base on the controller being configured to automatically re-activate the peripheral device 30 upon receiving a signal from the detector indicating that the surgical garment 12 is disposed over the surgical helmet 20.

It is also contemplated that the controller may be configured to operate the peripheral device 30 based on a combination of signals from either of the user input device 60 and/or the detector. For example, upon connection of the energy source, the controller may be configured to automatically activate the peripheral device 30. The user may then manipulate the user input device 60, such as pressing a pause button, to signal to the controller to deactivate the peripheral device 30. The peripheral device 30 may then be reactivated by control upon the controller receiving a signal from the detector 70 indicating that the surgical garment 12 has been coupled to the surgical helmet 20.

The controller may further be configured to subsequently de-activate the peripheral device following upon the controller receiving a subsequent signal from the detector 70 indicating that the surgical garment 12 has been de-coupled or removed from surgical helmet 20. For example, the controller may activate the peripheral device 30 up on receipt of a signal from the detector 70 indicating that the surgical garment 12 has been coupled to the surgical helmet 20. The controller may then receive a second signal from the from the detector 70 indicating that the surgical garment 12 has been de-coupled from surgical helmet 20, at which point he controller may be configured to de-activate the peripheral device 30.

The user inputs 60A, 60B, 60C may be disposed on the lower beam 28 of the chin bar 24 of the surgical helmet 20. While not shown in the Figures, it is also contemplated that the user input device 60 may be disposed on the posts 26 of the chin bar 24. It is further contemplated that the user input device 60 may also be disposed on the housing 32 of the surgical helmet 20, or another location on the surgical helmet 20 where the user input device 60 would be accessible to the user. While not required, it is preferable that the user input device 60 is disposed on the surgical helmet 20 in a location that is accessible to the user when the surgical garment 12 is disposed over the surgical helmet 20.

Method of Operating the Surgical Apparel Systems Described Above:

A method of operating a surgical apparel system 10 may comprise providing any configuration of the surgical apparel systems 10 described above. For example, the method may comprise providing a surgical helmet 20 configured to be worn on the head of an individual, and a surgical garment 12 configured to be removably coupled to the surgical helmet 20 to provide a microbial barrier between a medical environment and a wearer. The surgical helmet 20 may comprise one or more peripheral device(s) 30 configured to facilitate performance of the individual wearing the surgical helmet 20 during a surgical procedure. The surgical helmet 20 may also optionally comprise one or more user inputs 60 configure to manipulate an operational characteristic of the one or more peripheral device(s) 30. The surgical helmet 20 may also comprise a detector 70 configured to detect the coupling of the surgical garment 12 to the surgical helmet 20 and to communicate a signal based, at least in part, on the presence or absence of the surgical garment 12 being coupled to the surgical helmet 20. A controller may also be coupled to the surgical helmet 20 and configured to be in communication with the detector 70 and/or the peripheral device(s) 30. The system 10 may also comprise, a portable energy source removably interconnected with the surgical helmet 20. The portable energy source may be configured to be in communication with the controller, and the controller may be configured to manipulate the flow of voltage and/or amperes to the one or more peripheral devices based, at least in part, on signals received from the user input device 60 and/or the detector.

The method may further comprise attaching or coupling the portable energy source to the system 10. For example, an energy source, such as a battery pack, may be coupled to the surgical helmet 20 or otherwise placed in electrical communication with the surgical helmet 20.

Upon coupling of the energy source to the surgical helmet 20, the controller may be configured to automatically activate the peripheral device 30 of the surgical helmet 20. Prior to a surgical garment 12 being disposed over the surgical helmet 20, as described above, the controller may be configured to activate the peripheral device 30 for a defined period of time, such as five seconds (5-sec.), following the energy source being connected to the surgical helmet. After the passage of the defined period of time, the method may include the controller deactivating the peripheral device 30 in absence of a surgical garment 12 being disposed over the surgical helmet 20. However, if the controller receives a signal from the detector 70 indicating that a surgical garment 12 is disposed over the surgical helmet 20, the controller may be configured to allow continued activation of the peripheral device 30.

Alternatively, the method may comprise activating the peripheral device 30 once the energy source has been connected to the surgical helmet 20 until the controller receives a signal from the user input device 60 indicating that the controller should deactivate the peripheral device 30. For example, the controller may activate the peripheral device 30 upon connection of the energy source, and then deactivate the peripheral device 30 once the controller receives a signal from the user input device 60 based on manipulation the user input device 60 by the user. This may include the user pressing a user input device 60, such as pause and/or on/off button on the surgical helmet 20. In this scenario, the controller may be configured to maintain the deactivation of the peripheral device 30 until a subsequent signal is received from one of the detector 70 and/or the user input device 60. For example, the controller may maintain the deactivation of the peripheral device 30 until the controller receives a signal from the detector 70 indicating a surgical garment 12 is disposed over the surgical helmet 20. The detector 70 may comprise a Hall Effect sensor configured to determine the presence or absence of the surgical garment 12 being coupled to the surgical helmet 20 based on a change in the magnetic field surrounding the coupling members 48 of the surgical helmet that is caused by the proximity of attachment elements 58 relative to the coupling members 48. The detector 70 may also comprise a reader, such as an RFID reader, configured to determine the presence or absence of the surgical garment 12 being coupled to the surgical helmet 20 based the RFID reader communicating with an electromagnetic tag 92, i.e. an RFID tag, on the surgical garment 12. One of the many purposes of the peripheral device 30, such as a ventilation assembly, is to circulate air under the surgical garment 12 to prevent the buildup of CO₂ when the system 10 is worn. Therefore, activation of the peripheral device 30 is most useful when the surgical garment 12 is disposed over the surgical helmet 20.

The method may also comprise the controller being configured to maintain the deactivation of the peripheral device 30 until the controller receives a subsequent signal from the user input device 60 indicating the user has manipulated the user input to re-activate the peripheral device 30.

The surgical helmet 20 of the system 10 may further comprise a memory device coupled to the surgical helmet 20 and in communication with the controller. The memory device may be configured to store data related to the operation of the peripheral device(s) 30. The data on the memory device may comprise current operational settings for the peripheral device(s), such as the fan speed, cooling intensity, and/or the light being on. The data on the memory device may also include maximum and minimum operating conditions for each of the peripheral device(s) 30 of the surgical helmet 20. The method may further comprise controlling an operational characteristic of the peripheral device(s) 30 based, at least in part, on the manipulation of the user input device 60 by the user. The peripheral device 30 may be activated to run at a default operation setting upon connecting the energy source to the surgical helmet 20. While the peripheral device 30 is activated the user may manipulate one or more user inputs 60 to set an operational settings of the peripheral device 30. For example, while the peripheral device 30, such as the ventilation assembly, is activated, the user may manipulate the user input device 60A, 60B to set a fan speed for the ventilation assembly. The method may include the storing operational setting, such as the fan speed, prior the peripheral device 30 being deactivated in one of the manners described above (the user input device 60 or time interval). Then upon reactivation of the peripheral device 30, the controller may be configured to reactivate the peripheral device 30 based on the stored operation setting in the memory.

The method may further comprise coupling the surgical garment 12 to the surgical helmet 20, such that the surgical garment 12 is at least partially disposed over the surgical helmet 20. The surgical garment 12 may be coupled to the surgical helmet 20 using any of the configuration of the attachment elements 58, coupling members 48 and the coupling features 46 described above, or others not specifically described. This may include placing attachment elements 58 of the surgical garment 12 adjacent to the coupling members 48 and/or the coupling features 46 of the surgical helmet 20.

The method may further comprise replacing the energy source with a second energy source while the surgical garment 12 is coupled to the surgical helmet 20. The controller may be configured to provide a signal to the peripheral device 10 based on the user settings from the memory device to the peripheral device(s) 30, such as the most recently stored user settings, once the second energy source is connected to the system 10. The controller may be further configured to restart the peripheral device(s) 30 based on the most recently stored user settings following replacing the energy source. This may be contingent on the signal from the detector 170, 70 indicating that the surgical garment 12 remained coupled to the surgical helmet 20 while the energy source was replaced, i.e., the controller did not receive a signal from the detector indicative of the garment being decoupled from the surgical helmet 20 while either the first or second energy source was in communication with the controller. For example, if the user was operating a peripheral device 30, such as the ventilation assembly at the third fan speed setting, the controller may be configured to restart the ventilation assembly 30 at the third fan speed setting once the second energy source is connected. This configuration of the system may further comprise a capacitor or secondary back-up energy source in communication with the detector 70, and configured to temporarily supply power to the detector 70 while the energy source is switched out. This will allow the detector 70 to continue to detect the characteristic indicative of whether the surgical garment 12 remains coupled to the surgical helmet 20.

The method may also comprise deleting the user settings for the peripheral device(s) 30 stored on the memory device when the detector 70 indicates that the surgical garment 12 is separated or absent from the surgical helmet 20 and/or the energy source or subsequent energy source is disconnected from the system 10. Once the surgical garment and the energy source have both been removed from the surgical helmet 20, the stored user settings related to operation of the peripheral device(s) 30 may be cleared from the memory device, and the peripheral device(s) 30 may be reset to their default settings.

In another exemplary configuration, the method may further comprise the steps of storing a user setting of the peripheral device(s) 30 on the memory device and separating the surgical garment 12 from surgical helmet 20 while the energy source is in communication with the controller. The controller may cease providing power to the peripheral devices 30 if the detector 70 determines that the surgical garment 12 is separated from the surgical helmet 20. Following removal of the first surgical garment 12, a second surgical garment 12 may be coupled to the surgical helmet 20 while the energy source remains in communication with the controller. The controller may be configured to communicate the most recently stored user settings from the memory device to the peripheral device(s) 30 following coupling of the second surgical garment 12 with the surgical helmet 20. In doing so, the controller may be configured to restart the peripheral device(s) 30 based on the most recently stored settings prior to removal of the first surgical garment 12.

The method may further comprise deleting the user settings of the peripheral device(s) 30 that are stored on the memory device when the detector 70 indicates to the controller that the surgical garment 12 is separated from the surgical helmet 20 and the energy source is disconnected from the surgical helmet 20. This may restore or reset the peripheral device(s) 30 to their default settings.

In another exemplary configuration of the system 10, the system 10 may be configured so that the controller may activate the peripheral device(s) 30 for a predetermined period of time once an energy source is attached to the surgical helmet 20. This may allow the controller to complete a status check and confirm the peripheral device(s) 30 are functioning properly. Once the controller has completed the status check, the controller may be configured to prevent any further actuation of the peripheral device(s) 30 until the controller receives a signal from the garment detector indicating that the surgical garment 12 has been attached to the surgical helmet 20. Upon the controller receiving a signal from the garment detector indicating the surgical garment 12 has been attached to the surgical helmet 20, the controller may be configured to generate an operational command to allow the transmission of energy from the energy source to the peripheral device(s) 30.

The above are not directed to specific configurations of the surgical apparel system 10. It should be understood that the individual features of the different configurations of the system 10 may be combined to construct alternative configurations of the system 10.

Also, while the surgical apparel system 10 is generally intended to provide a barrier between the medical practitioner and the patient during a medical or surgical procedure, its use is not so limited. It is within the scope of this disclosure that the surgical apparel system 10 may be used in other endeavors in which it is desirable to provide a barrier between an individual and the surrounding environment. One alternative endeavor in which it may be so desirable to use the system 10 is one in which it is desirable to provide a barrier between the individual and hazardous material in the environment in which the individual is working.

Clauses covering additional configurations of the system(s) described above:

I. A method of operating a peripheral device of a surgical helmet, said method comprising:

automatically actuating a peripheral device of the surgical helmet upon creating an electrical connection between a power source and the surgical helmet;

pausing actuation of the peripheral device upon receipt of a user input signal on the surgical helmet; and

automatically resuming actuation of the peripheral device upon detection of a surgical garment being disposed over the surgical helmet.

II. The method of clause I, further comprises an initial step of connecting a power source to the surgical helmet to power the peripheral device.
III. The method of clause I or II, further comprising the step of setting an operational characteristic of the peripheral device prior to pausing actuation of the peripheral device.
IV. The method of clause III, wherein the peripheral device comprises a ventilation assembly including a fan; and

wherein said step of setting an operational characteristic of the peripheral device prior to pausing actuation of the peripheral device comprises setting a speed of the fan prior to pausing actuation of the peripheral device.

V. The method of clause IV, wherein the step of automatically resuming actuation of the peripheral device following the pausing actuation of the peripheral device upon the surgical garment being disposed over the surgical helmet comprises resuming actuation of the fan at the set speed.
VI. The method of any one of clauses I to V, further comprising the step of pausing actuation of the peripheral device comprises manipulating a user input to produce a user input signal to resume actuation of the peripheral device upon the surgical garment being disposed over the surgical helmet.
VII. The method of any one of clauses I to VI, further comprising the step of coupling an attachment member of the surgical garment with a coupling member on the surgical helmet to resume actuation of the peripheral device.
VIII. The method of clause VII, wherein the surgical helmet further comprises a sensor for detecting the coupling of the attachment member of the surgical garment with the coupling member on the surgical helmet; and

wherein the sensor is configured to trigger the step of resuming actuation of the peripheral device upon detecting the coupling of the attachment member of the surgical garment with the coupling member on the surgical helmet.

IX. The method of clause VIII, wherein the sensor comprises a hall effect sensor configured to detect the coupling of the attachment member of the surgical garment with the coupling member on the surgical helmet.
X. A method of actuating a ventilation unit of a surgical helmet, said method comprising:

automatically actuating a peripheral device of the surgical helmet upon creating an electrical connection between a power source and the surgical helmet;

pausing actuation of the peripheral device by manipulating a user input on the surgical helmet a first time; and

resuming actuation of the peripheral device by manipulating a user input on the surgical helmet a second time.

XI. The method of clause X, further comprising the step of disposing a surgical garment over the surgical helmet after pausing actuation of the peripheral device.
XII. The method of clause X, further comprising the step of disposing a surgical garment over the surgical helmet after the step of pausing actuation of the peripheral device and before the step of resuming actuation of the peripheral device.
XIII. The method of clause X, further comprises an initial step of connecting a power source to the surgical helmet to power the peripheral device.
XIV. The method of any one of clauses X or XIII, further comprising the step of setting an operational characteristic of the peripheral device prior to pausing actuation of the peripheral device.
XV. The method of clause XIV, wherein the peripheral device comprises a ventilation assembly including a fan; and

wherein said step of setting an operational characteristic of the peripheral device prior to pausing actuation of the peripheral device comprises setting a speed of the fan prior to pausing actuation of the peripheral device.

XVI. A surgical apparel system comprising:

a surgical helmet comprising:
a peripheral device;
a controller electrically connected to said peripheral device and configured to control operation of said peripheral device;
a user input disposed on said surgical helmet and is manipulatable by a user, said user input in electrical communication with said controller; and
a sensor disposed in electrical communication with said controller;

a surgical garment configured to be at least partially disposed over said surgical helmet to provide a microbial barrier between a medical environment and the user; and

a power source removably coupled to said surgical helmet;

wherein said sensor is configured to detect the presence or absence of said surgical garment being disposed over said surgical helmet; and

wherein said controller is configured to automatically actuate said peripheral device when the power source is connected to said surgical helmet, to deactivate said peripheral device when the user manipulates said user input, and to automatically re-actuate said peripheral device when said sensor detects the presence of the surgical garment.

XVII. The surgical apparel system of clause XVI, wherein said surgical garment comprises:

a surgical fabric defining an opening configured to be positioned in front of the face of the wearer when at least partially disposed over said surgical helmet;

a transparent face shield disposed within said opening of said surgical fabric; and

an attachment member coupled to said transparent face shield, said attachment member configured to removably couple said surgical garment to said surgical helmet.

XVIII. The surgical apparel system of clause XVII, wherein said attachment member of said surgical garment comprises one of a ferromagnetic material or a magnetic material; and

wherein said surgical helmet further comprises a coupling member comprising the other of the ferromagnetic material or the magnetic material; and

wherein said sensor is a Hall Effect sensor configured to detect the presence or absence of said attachment member of said surgical garment being positioned adjacent said coupling member of said surgical helmet.

XIX. The surgical helmet of clause XVIII, further comprising a chin bar extending from said helmet base;

wherein said coupling member and said sensor are disposed on said chin bar.

XX. The surgical helmet of clause XIX, wherein said coupling member is disposed within a recess of said chin bar and having a distal surface positioned proximal to said distal surface of said chin bar, said coupling member comprising one of a ferromagnetic material or a magnetic material.
XXI. The surgical helmet of any one of clauses XVI to XX, wherein said peripheral device comprises a ventilation assembly including a fan.
XXII. The surgical helmet of any one of clauses XVI to XXI, wherein the user input comprises a button configured to be manipulatable by the user.

Several configurations have been discussed in the foregoing description. However, the configurations discussed herein are not intended to be exhaustive or limit the system 10 to any particular form. The terminology which has been used is intended to be in the nature of words of description rather than of limitation. Many modifications and variations are possible in light of the above teachings and the system may be practiced otherwise than as specifically described. Furthermore, it should be understood that elements described in the various configurations including reference numbers in increments of 100 may comprise similar features.

What is claimed is:

1. A method of controlling a peripheral device of a surgical helmet, said method comprising:
connecting a power source to a connector of the surgical helmet;
automatically actuating the peripheral device of the surgical helmet upon connecting the power source to the connector of the surgical helmet;
pausing actuation of the peripheral device based on receipt of a user input signal from a user input device coupled to the surgical helmet;
disposing a surgical garment over the surgical helmet after pausing the actuation of the peripheral device;
coupling the surgical garment to the surgical helmet;
automatically resuming actuation of the peripheral device when the surgical garment is coupled to the surgical helmet.

2. The method of claim 1, wherein the peripheral device comprises a ventilation assembly and the user input device comprises a button; and
wherein the step of pausing actuation of the peripheral device comprises manipulating the button to produce the user input signal to control the ventilation assembly.

3. The method of claim 1, wherein the peripheral device comprises a light assembly and the user input device comprises a button; and
wherein the step of pausing actuation of the peripheral device comprises manipulating the button to produce the user input signal to control the light assembly.

4. The method of claim 1, wherein the step of coupling the surgical garment to the surgical helmet comprises the step of coupling an attachment member of the surgical garment with a coupling member on the surgical helmet.

5. The method of claim 4, wherein the surgical helmet further comprises a sensor for detecting the coupling of the attachment member of the surgical garment with the coupling member on the surgical helmet; and
wherein the sensor is configured to trigger the step of resuming actuation of the peripheral device upon detecting the coupling of the attachment member of the surgical garment with the coupling member on the surgical helmet.

6. The method of claim 5, wherein the sensor comprises a hall effect sensor configured to detect the coupling of the attachment member of the surgical garment with the coupling member on the surgical helmet.

7. The method of claim 2, wherein the ventilation assembly comprises a fan; and
wherein actuating the ventilation assembly comprises rotating the fan.

8. The method of claim 1, wherein the power source comprises a battery, and wherein the step of connecting a power source to the surgical helmet to power the peripheral device comprises creating an electrical connection between the battery and the peripheral device.

9. The method of claim 2, further comprising the step of storing an operational parameter of the ventilation assembly prior to pausing actuation of the ventilation assembly.

10. The method of claim 9, wherein said step of storing an operational characteristic of the ventilation assembly comprises setting a speed.

11. The method of claim 10, wherein the step of automatically resuming actuation of the ventilation assembly following coupling the surgical garment to the surgical helmet comprises resuming actuation of the fan at the set speed.

12. The method of claim 1, wherein the step of coupling the surgical garment to the surgical helmet comprises positioning the surgical garment relative to the surgical helmet such that a tag of the surgical helmet is within a read range of a reader of the surgical helmet.

13. The method of claim 12, wherein the tag is an RFID tag, and the reader is an RFID reader.

14. A surgical helmet for use with a surgical garment and a power source, said surgical helmet comprising:
a helmet base;
a sensor configured to detect a presence of the surgical garment;
a ventilation assembly coupled to said helmet base;
a controller electrically connected to said ventilation assembly and configured to control operation of said ventilation assembly;
a user input device coupled to said surgical helmet and in communication with said controller, said user input device being manipulatable by a user;
wherein said controller is configured to automatically actuate said ventilation assembly when the power source is connected to said surgical helmet, to manually deactivate said ventilation assembly when the user manipulates said user input device, and to automatically re-actuate said ventilation assembly when said sensor detects the presence of the surgical garment.

15. The surgical helmet of claim 14, further comprising a face frame coupled to the helmet base, the sensor being coupled to the face frame.

16. The surgical helmet of claim 14, wherein the face frame further comprises a chin bar, the sensor being coupled to the chin bar.

17. The surgical helmet of claim 15, further comprising a coupling member coupled to said chin bar said coupling member comprising one of a ferromagnetic material or a magnetic material; and
wherein the surgical garment further comprises an attachment member configured to removably couple with said coupling member of said surgical helmet to removably secure the surgical garment to said surgical helmet.

18. The surgical helmet of claim 14, wherein the sensor comprises a hall effect sensor; and
wherein the user input device comprises a button configured to be manipulatable by the user.

19. The surgical helmet of claim 14, wherein the surgical garment comprises a tag; and
wherein the sensor comprises a tag reader, said sensor is configured to detect the presence when the tag reader is able to successfully read the tag of the surgical garment.

20. The surgical helmet of claim 19, wherein the tag is an RFID tag, and the tag reader is an RFID reader.
